(19) United States
(12) Patent Application Publication
(10) Pub. No.: US 2015/0310542 A1
(43) Pub. Date: Oct. 29, 2015

(54) MATCHING REAL ESTATE RENTERS WITH PROPERTY

(71) Applicant: DOUBLE CHECK SOLUTIONS LLC, Menlo Park, CA (US)

(72) Inventors: David FRAZEE, Menlo Park, CA (US); Mark KREITZMAN, Palos Verdes, CA (US); Joel SCHWARTZ, Encino, CA (US)

(21) Appl. No.: 14/660,879

(22) Filed: Mar. 17, 2015

Related U.S. Application Data
(60) Provisional application No. 61/973,062, filed on Mar. 31, 2014.

(51) Int. Cl. G06Q 30/06; G06Q 50/16

(52) U.S. Cl. CPC G06Q 30/0645; G06Q 50/16

(57) ABSTRACT

A renter and landlord friendly system ad method to compare property qualification scores for a renter, including having a renter fill out an online application to rent property; the application is submitted via renter's computing device to server; the server's decisioning engines process the application, verify submitted qualification data producing a score; and, renter interacts with user interface and estimates different sub scores which are used to generate a possible score.

### BACKGROUND

1. Field

This disclosure relates to helping renter's and landlords match up renters with properties.

2. General Background

Renters traditionally have limited choice in locating properties such as: online advertisements and postings, newspapers, social media and seeing a for rent sign. Landlords have fair housing act restrictions, Federal, State and local laws to comply with when offering properties. Property owners also must determine the risk of loss and quality of the applicants for rentals. Moreover, individual property owners may have different risk loss limits.

### DISCLOSURE

Briefly stated, the within disclosures solves the two key problems plaguing today's tenants and landlords:

1. Tenants want rentals (whether business or residential) in the best area for the best price.

2. Landlords want to have the best tenants paying a value for the use of the property that fits their profit and risk criteria.

Disclosed herein are aspects of a method to align renters with properties, the method including having a renter fill out an online application to rent property; the application is submitted via renter's computing device to a renters friend server (RFS); the RFS's decisioning engines process the application, verify submitted qualification data producing a score; and, the servers then match renter with qualified properties. In some instances the landlord's server (or a proxy server operating for the landlord) receives a renter's application and rate or value the application and place a numerical value on the applicant, based on the submitted and/or verified criteria submitted by renter, for a specific property.

Disclosed herein are aspects of a method to align renters with properties, the method including having a renter fill out an online application to rent property; the application is submitted via renter's computing device to a renters friend server (RFS); the RFS's decisioning engines process the application, verify submitted qualification data producing a score; and, the servers then match renter with qualified properties. In some instances the landlord's server (or a proxy server operating for the landlord) receives a renter's application and rate or value the application and place a numerical value on the applicant, based on the submitted and/or verified criteria submitted by renter, for a specific property. In some instances the landlords server sends renter (or renters agent) a bid or offer to renter whose applications met a threshold value

Disclosed herein are aspects of a method to estimate a prospective renters qualification for rental properties, the method including a renter provides criteria estimates to RFS of renters values for criteria used in determining eligibility to rent particular properties; a SCORE is generated; and, RFS estimator decisioning engines process the data, and matches renter with a property list based on the estimated criteria. In some instances the renter using a user interface to adjust one or more rental criteria thereby changing SCORE; and RFS updates potential property list . In some instances the criteria are at least one of assets, Co-signer, assurance, and location.

Disclosed herein are aspects of a method to compare score increases for a renter, the method including a renter fills out online application to rent property; application is submitted via renter's computing device to server; server's decisioning engines process the application, verify submitted qualification data producing a score; and, renter interacts with user interface and estimates different sub scores which are used to generate a possible SCORE.

A renter and landlord friendly system and method to compare property qualification scores for a renter, including having a renter fill out an online application to rent property; the application is submitted via renter's computing device to server; the server's decisioning engines process the application, verify submitted qualification data producing a score; and, renter interacts with user interface and estimates different sub scores which are used to generate a possible score. The possible score is then used to identify the properties which could be available to that renter if the criteria which produce the score are met at the value levels set forth in the possible score. The RFS then gives the potential renter options for a third party to provide acquire a co-signor, a secure deposit, rent break assurance or correct negative credit score data or remove negative social media data.

### DRAWINGS

The above-mentioned features of the present disclosure will become more apparent with reference to the following description taken in conjunction with the accompanying drawings wherein like reference numerals denote like elements and in which:

FIG. 1 is an overview of the disclosure;

FIG. 2 is a system overview of the disclosure;

FIG. 3 is a verification module overview;

FIG. 4 is an estimator module;

FIG. 5 is a property matching overview;

FIG. 6 is an overview of some user interface aspects of an estimator engine; and

FIG. 7 is a property matching overview.

As shall be appreciated by those having ordinary skill in the art, the figures are not to scale, and modifications to scale within a figure or across the figures are considered within the present disclosure. All call outs in the figures are hereby incorporated by reference as if fully set forth herein.

### FURTHER DESCRIPTION

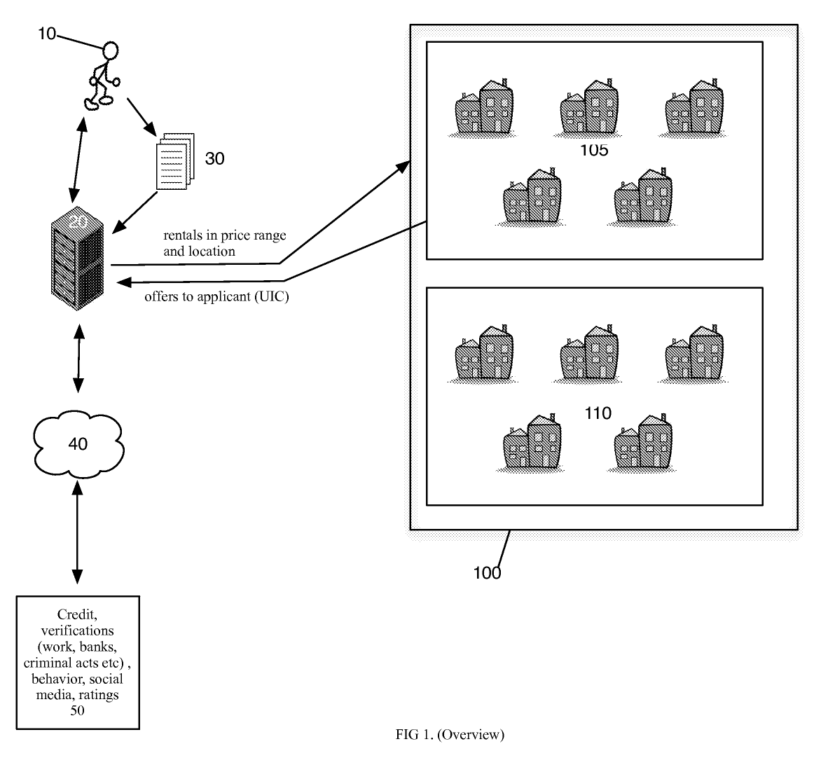

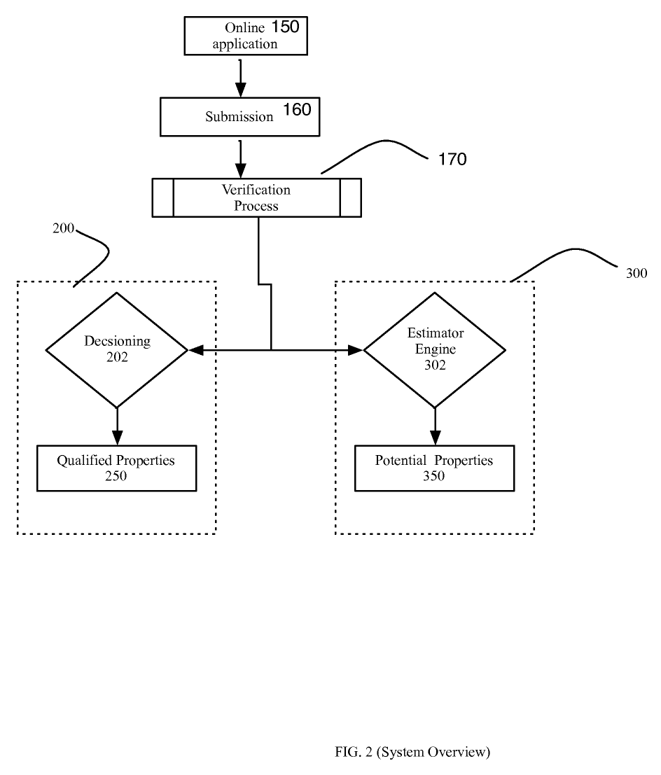

According to one or more exemplary implementations, as shown in FIGS. 1-6, a User 10 interacts with the renter's friend server (RFS) 20 via an online interface on the users smart phone, computing device, mobile device, smart TV or computer. The user may also fill out an online application 30 rather than proceeding as a guest.

A guest user will be able to provide in-verified information about his/her assets, liabilities, credit scores, legal issues (at least one of misdemeanors, felonies, arrests, legal status, bankruptcy, liens, judgments, lawsuits, divorce, support obligations, and the like), employment history, social network filter (safe, moderate or none. Meaning does the potential renter post everything about themselves including illegal or offensive acts, does the user use good judgment in what was posted by him/her, does the potential renter even have a Facebook™ or other social network identity), would a quality co-signor be used, rental history, will potential renter have insurance (liability, theft, and/or car), does the potential renter have rental assurance for lease break, rent limits, security and 1^{st} and last month limit, and what are the location parameters for the potential rental.

Via one or more rule and decision the engines in the RFS 20 a database of properties 100 for lease or rent is searched and a subset of match properties 105 is identified that are a potential good fit for the user and a subset of unmatched properties 110 remains.

When matching users and properties property limits are utilized to set thresholds for potential tenants. Property limits reflect the minimum criteria that a property owner wants to see met to consider a user's application for rent. The system disclosed herein can reflect the property owners criteria in user (potential tenant) verification variables, including but not limited to altering the variable list to include criteria specific to a property, ordering the criteria list to emphasize heavily weighted criteria and make offers to the potential tenant with ancillary products such as:

1. High quality co-signor;

2. Funded security deposit and/or 1^{st} and last;

3. Social network clean up;

4. Insurance;

5. Rent break assurance (pre-negotiated damages);

6. Clean up unfair rental history; and

7. Credit clean up for unfair or untrue items.

Broken into some of the basic steps, the system provides an online application 150. The application may be a fee related transaction. The application is submitted 160 to the RFS to complete a verification process 170. The verification process is, at least in part, preferably computerized. Some aspects of the verification may require human interaction to verify employment for example. One of a scraping engine and web crawler pulls social network and/or public domain records concerning the user from internet connected sources. Once the verification items or criteria are collected the may be provided to a decisioning engine 202 to identify properties that the user 10 appears to match. Alternatively or in addition, the verification items and criteria collected, which may include the user's estimates on what he/she thinks they can improve in their criteria, is be provided to an estimator engine 302 which identifies potential properties for the user based on the user estimates.

Not shown is an additional engine which compares user actual verification data and user estimated improved data to determine if the user's estimates are too low or too high and the engine may provide, via the RFS, feedback to the user on same. RFS servers can be used to direct potential renter to services and products that provide credit repair, co-signors, rent break assurance and secure down payments.

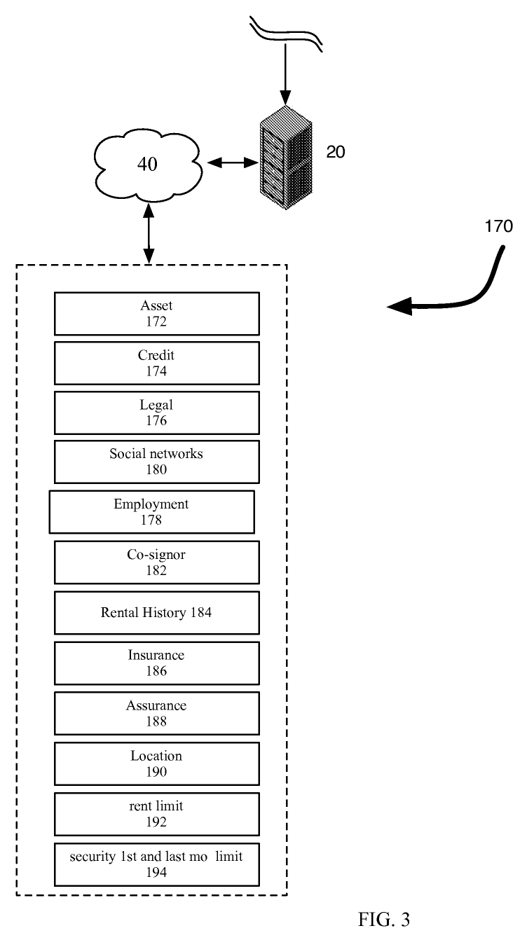

The verification system can be broken down into the twelve criteria illustrated in FIG. 3. However, those of ordinary skill in the art will recognize that the number of criteria may be fewer or greater without departing from the scope of the disclosure.

Criteria verified or confirmed with or for user may include assets 172, Credit score 174, legal 176, employment 178, social network 180, co-signer 182, rental history 184, insurance 186, assurance 188, location 190, rent limit 192 and ability to pay security deposit and 1^{st} and last months rent 194. The information is collected by the RFS 30 and provided to the MATCHING SYSTEM 200 to identify qualified properties 250.

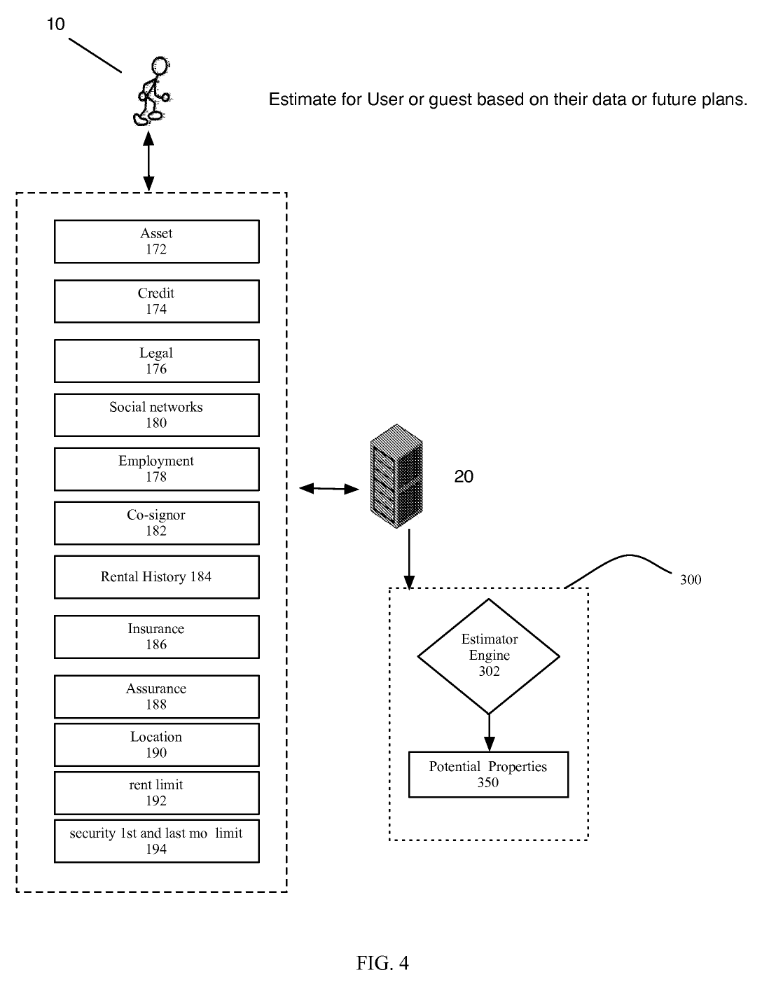

When the user is one of a guest (not registered) or a user who only wants to estimate his/her strength as a renter and ability to rent specified property types criteria are not verified (FIG. 4), rather, the user provides self estimates for assets 172, Credit score 174, legal 176, employment 178, social network 180, co-signer 182, rental history 184, insurance 186, assurance 188, location 190, rent limit 192 and ability to pay security deposit and 1^{st} and last months rent 194. The information is collected by the RFS 30 and provided to the ESTIMATOR SYSTEM 300 to identify potential properties 350.

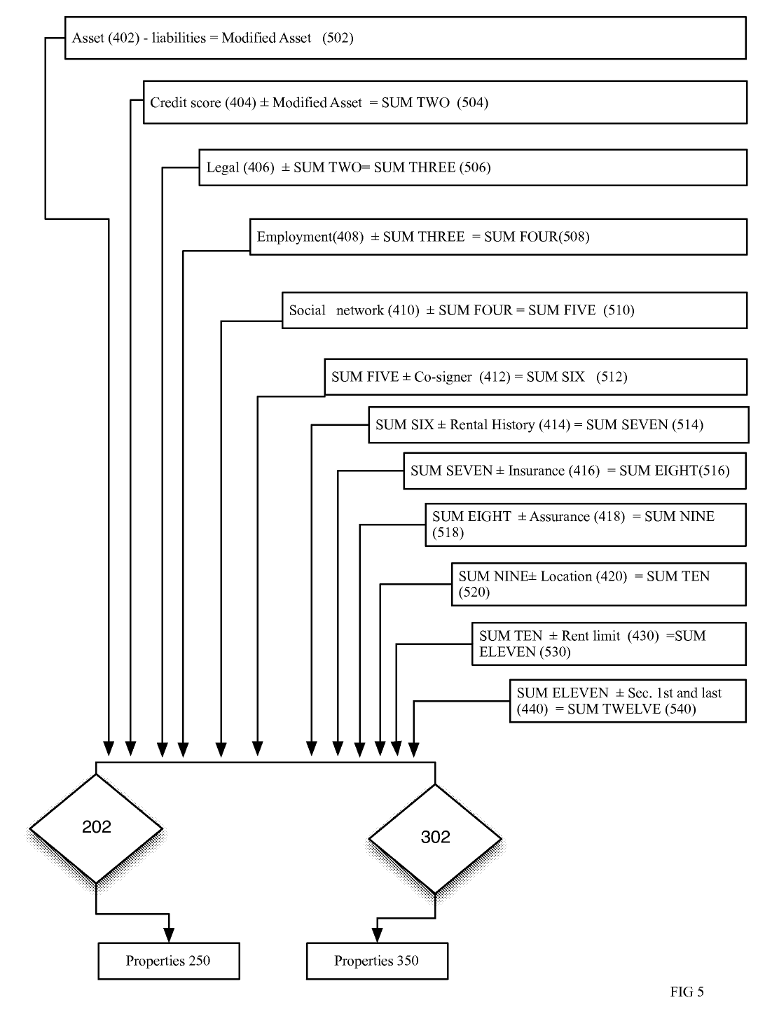

FIG. 5 illustrates the use of the criteria in an ESTIMATOR SYSTEM or a MATCHING SYSTEM. Twelve criteria are show, The criteria may be used separately or combined when provided to at least one of the MATCHING and ESTIMATOR SYSTEMS. For example systems may be additive wherein at least a portion of the twelve variables are added (or subtracted) as shown in FIG. 5 wherein the sum of the variables after the decisioning engine(s) 202/302 applies the criteria subjective value, per the landlord/property owners choices, to obtain a raw score that equates with qualified properties 250 or potential properties 350 sting of variables such as the twelve shown.

One, non-limiting example of an additive system is sown in FIG. 5 wherein Assets 402 minus liabilities 403 is used to derive a Modified Asset value 502. That value is based on a numerical weight being assigned to Modified Asset value 502; numerical weight may vary depending on the rental property criteria requirements and valuations. That summation may then be provided to one or both of the decisioning engines 202 and 302 wherein qualified and potential properties are identified.

The same system may be used to combine a Credit score 404 with the Modified Asset 502 wherein SUM TWO 504 is derived. SUM TWO 504 may then be provided to one or both of the decisioning engines 202 and 302 wherein qualified and potential properties are identified.

The same system may be used to combine a legal score 406 with SUM TWO 504 wherein SUM THREE 506 is derived. SUM THREE 506 may then be provided to one or both of the decisioning engines 202 and 302 wherein qualified and potential properties are identified.

The same system may be used to combine an employment score 408 with SUM THREE 506 wherein SUM FOUR 508 is derived. SUM FOUR 508 may then be provided to one or both of the decisioning engines 202 and 302 wherein qualified and potential properties are identified.

The same system may be used to combine a social network score 410 is combined with SUM FOUR 508 wherein SUM FIVE 510 is derived. SUM FIVE 510 may then be provided to one or both of the decisioning engines 202 and 302 wherein qualified and potential properties are identified.

The same system may be used to combine a Co-signor score 412 is combined with SUM FIVE 510 wherein SUM SIX 512 is derived. SUM SIX 512 may then be provided to one or both of the decisioning engines 202 and 302 wherein qualified and potential properties are identified and so forth. Wherein a rental history score 414 may be combined with SUM SIX 512 to derive SUM SEVEN 514; an insurance score 416 may be combined with SUM SEVEN 514 to derive SUM EIGHT 516; an assurance score 418 may be combined with SUM EIGHT 516 to derive SUM NINE 518; a location score 420 may be combined with SUM NINE 518 to derive SUM TEN 520; a rent limit score 430 may be combined with SUM TEN 520 to derive SUM ELEVEN 530; and, a security deposit/1^{st} and last month rent deposit score 440 may be combined with SUM ELEVEN 530 to derive SUM TWELVE 540.

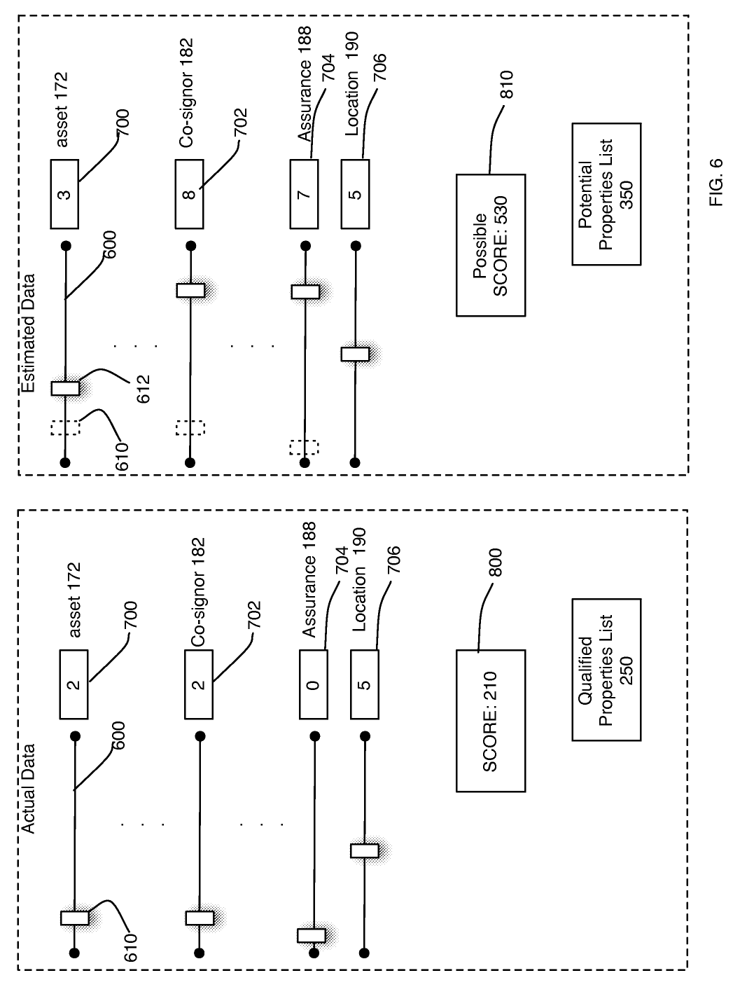

FIG. 6 illustrates major components of a user interface (UI) wherein the user is allowed to select a value on a visual scale 600 by positioning a marker 610. The scale 600 can be alpha numeric, zip code, dollar valuation, time etc. To the right of the scale 600 is a value display 700 showing the value selected. The asset 172 shown herein is valued at “2” in the value display 700 the co-signor value 182 is valued at “2” in the value display 702, the assurance 188 value is “0” shown in display 704 and the Location 190 value is “5” in the value display 706. A score of 210 is displayed in score display 800. The score is run through the decision and rule engines along with other data supplied by the user and the qualified list of properties 250 is generated.

FIG. 6 also illustrates major components of a user interface (UI) wherein the user is allowed to estimate a value on a visual scale 600 by positioning a marker 610. The asset marker 610 has been moved to a higher value 612 on the scale 600. In this example the asset 172 value has been moved from “2” to “3” in the value display 700, the co-signor value 182 in display box 172 has increased from “2” to “8” as shown in the value display 704, the assurance 188 value has increased to “7” and the Location 190 value remains “5” in the value display 706. A Score of 530 is displayed in score display 800. The score is run through the decision and rule engines along with other data supplied by the user and the qualified list of potential properties 350 is generated. The methodology to move the markers may be moving and dragging with a touch screen or mouse. They also may move in response to entry of data. For example if the user proposes a co-signor with at least one of assets at a certain threshold or a credit score above a threshold then a numeric value is generated. With respect to rent break assurance, if the user proposes the pay the rent break assurance up front or to buy a high level of coverage then the score will be higher than no rent break assurance or only agreeing to a low level thereof.

Land owners will now have access to a pool of qualified renters who meet the objective criteria and subjective criteria they desire. Renters will have access to properties which they have higher probabilities of renting. A renter that wants to increase the type of property he/she wants can take advantage of high quality co-signers and deposit loans or rent break assurance as set firth herein and as shown in the estimation calculations.

Landlords who have specified the desire for rent break assurance r higher quality co-signers benefit from applicants who have already been through an application process and have the option for such additional desirable attributes to be connected with their applications.

Rent break assurance is a product/service wherein a renter pays a premium to have an objective cost for lease break accepted by the landlord. The landlord benefits with a written and agreed to set of terms for lease break.

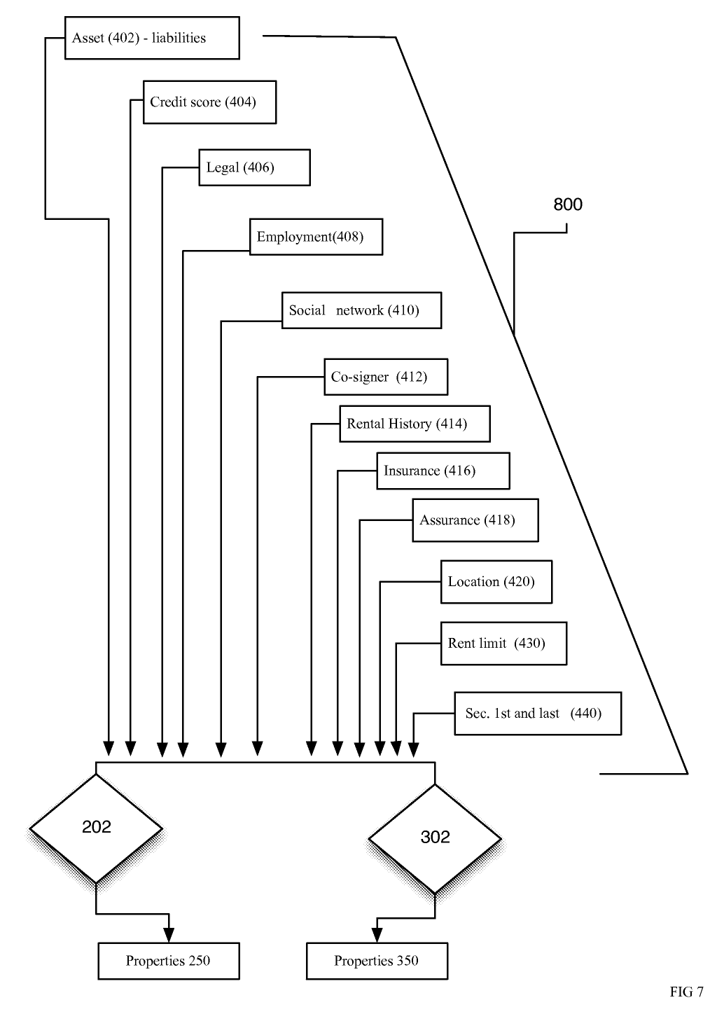

FIG. 7 illustrates the use of the criteria in an ESTIMATOR SYSTEM or a MATCHING SYSTEM. Twelve criteria are show, The criteria may be used separately or combined in any grouping with any weighting suitable for a give property.

When a potential renter populates his/her application participating or interested landlords are able to have their properties matched up with the applicant whereby the applicant may receive offers to rent from landlords. Said offers may be time sensitive. A renter may also be allowed to pay an option fee to hold an offer open for a given period of time.

Those of ordinary skill in the art will recognize that a smart phone application can be used to provide the user interface and to send notification via the app, text or email on status of an application and offers made by landlords.

While the method and agent have been described in terms of what are presently considered to be the most practical and preferred implementations, it is to be understood that the disclosure need not be limited to the disclosed implementations. It is intended to cover various modifications and similar arrangements included within the spirit and scope of the claims, the scope of which should be accorded the broadest interpretation so as to encompass all such modifications and similar structures. The present disclosure includes any and all implementations of the following claims.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects of the disclosure both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the disclosure, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these disclosure(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular implementation, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative implementations.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A method to align renters with properties, the method comprising: renter (10) fills out online application (30) to rent property; application is submitted via renter's computing device to server (20); server's decisioning engines (202) process the application, verify submitted qualification data producing a score (800); and servers then match the renter with qualified properties.

2. The method of claim 1, the method further comprising landlord servers receive a renter's application and rate the application and place a value on the applicant for a specific property.

3. The method of claim 2, the method further comprising landlord servers bid for or submit an offer to renters whose applications meet a threshold value.

4. A method to estimate a prospective renter's qualifications for rental properties, the method comprising: renter (10) provides criteria estimates to server (20) of renters values for criteria used in determining eligibility to rent particular properties; a SCORE (810) is generated; and, server's estimator decisioning engines (302) process the data, and matches renter with a property list (350).

5. The method of claim 4, the method further comprising the renter using a user interface to adjust one or more rental criteria thereby changing SCORE (530); server updates potential property list (350).

6. The method of claim 4, wherein the criteria are at least one of asset (172), Co-signer (182), assurance (188), and location (190).

7. A method to compare score increases for a renter, the method comprising: renter (10) fills out online application (30) to rent property; application is submitted via renter's computing device to server (20); server's decisioning engines (202) process the application, verify submitted qualification data producing a score (800); and, renter interacts with user interface and estimates different sub scores (700, 702, 704 and 706) which are used to generate a possible SCORE (810).
